(19) United States
(12) Patent Application Publication
(10) Pub. No.: US 2026/0301299 A1
(43) Pub. Date: Oct. 1, 2026

(54) THREE-DIMENSIONAL SCENE PROCESSING SYSTEM

(71) Applicant: Hitachi, Ltd., Tokyo (JP)

(72) Inventors: Yi He, Tokyo (JP); Yuki Watanabe, Tokyo (JP); Daisuke Yoshida, Tokyo (JP)

(73) Assignee: Hitachi, Ltd., Tokyo (JP)

(21) Appl. No.: 19/538,529

(22) Filed: Feb. 12, 2026

(30) Foreign Application Priority Data
Mar. 26, 2025 (JP) 2025-052197

(51) Int. Cl. G06T 15/00

(52) U.S. Cl. CPC G06T 15/005

(57) ABSTRACT

A three-dimensional scene processing system includes one or more processors and one or more storage devices. The one or more storage devices store a first three-dimensional representation model representing a three-dimensional scene. The one or more processors are configured to execute acquiring an update image corresponding to a part of the three-dimensional scene, estimating an update geometry representation and an update camera pose from the update image, generating a three-dimensional representation model for update by the update geometry representation and the update camera pose, and updating a local part of the first three-dimensional representation model by the three-dimensional representation model for update.

### CLAIM OF PRIORITY

This application claims priority from Japanese patent application JP 2025-052197 filed on Mar. 26, 2025, the content of which is hereby incorporated by reference into this application.

### BACKGROUND

This invention relates to a three-dimensional scene processing system.

Along with the expansion of metaverse, a more natural and immersive 3D environment is required in space construction and content generation. In order to realize this, a technique of efficiently constructing a high-definition 3D model at low cost and generating a high-quality rendering image by utilizing the 3D model is important. In this respect, a movement of integrating a multi-modal generative artificial intelligence (AI) and a metaverse technology has attracted attention.

Conventionally, as a 3D space reconstruction method, a method using a physical measurement means such as Laser Imaging Detection and Ranging (LiDAR) scanning or Structure from Motion (SfM) algorithm is generally used. While the 3D measurement by LiDAR can obtain a highly accurate point cloud, manual intervention of an operator skilled in the post process (cleaning of point cloud, mesh generation, texture application, etc.) after scanning is required, and there are large restrictions in terms of cost and time.

In the SfM method, a camera pose is estimated based on 2D images captured from a plurality of viewpoints to reconstruct a 3D structure, but this method also requires additional processing for high-quality texturing or photorealistic rendering. In these existing methods, sufficient efficiency and quality have not yet been obtained in response to a demand for generating a high-quality video seamlessly from various viewpoints in the metaverse space.

In recent years, with the advent of a technique called Neural Radiance Field (NeRF), high-quality rendering image generation using a neural network has attracted attention. NeRF is a major feature in that a radiance field of a 3D scene is expressed by a neural network, and a photorealistic image can be obtained from an arbitrary viewpoint. However, NeRF requires high computation cost for learning and inference, and is difficult to easily incorporate into an existing pipeline. This makes it difficult to utilize in a large-scale and dynamic 3D space such as metaverse.

Meanwhile, 3D Gaussian Splatting (3DGS) has attracted attention as an example of another type of approach for handling a scene from a geometrical and probabilistic viewpoint. 3DGS is a technique for modeling data, which has been handled as a simple “set of discrete points” in conventional point cloud representation, as a probabilistic “lump (splat)” by Gaussian distribution.

Specifically, the point cloud is sublimated into a smoother and continuous representation by approximating spatial information around each point with a Gaussian distribution centered on the point. As a result, even when the viewpoint of the camera is changed, it is possible to expect high-quality and flexible image generation as compared with a case where a simple set of points is projected as it is, and there is a possibility that it becomes easy to incorporate a view-dependent texture and lighting effects. In addition, it is considered that such representation by Gaussian distribution is also advantageous in terms of enhancing affinity with a visual-based AI method.

In recent years, image generative AI and image understanding AI often handle feature extraction at a pixel level and continuous luminance and color change, and 3D scene information represented by a Gaussian distribution provides a foundation for more smoothly accepting input processing and feedback by such an algorithm. As a result, 3DGS may play a bridging role in rendering 3D space efficiently and with high quality from a variety of viewpoints, as well as facilitating its output into an image generation model or visual analytics model.

In recent years, in some studies, there is also a movement to reduce strict dependence on a camera pose and a large preparation burden of multi-viewpoint information, and these preconditions are gradually alleviated. However, a technical basis for editing and updating a reconstructed scene is still not sufficiently prepared, and a problem for practical use still remains.

JP 2023-542063 A aims to solve a technical problem that realizes high-quality scene reconstruction at low cost and low resources by hybrid use of a 2.5D model and a 3D model in indoor scene reconstruction and enables application on a mobile device in real time. By clustering images obtained from a multi-viewpoint video stream with respect to a large-scale 3D scene, and training and integrating a plurality of NeRFs and an uncertainty MLP (Multilayer Perceptron), it is aimed to solve computational and technical problems (scale, fidelity, stability, computation cost), and enable new viewpoint synthesis and 3D reconstruction of a practical large-scale scene. Both have strict dependency on the input device or the input image, such as a camera pose, and are costly to reconstruct a three-dimensional scene.

On the other hand, in “3D Gaussian Editing with A Single Image” (Luo, Guan, et al. Proceedings of the 32nd ACM International Conference on Multimedia. 2024), arbitrary camera poses are sampled with respect to the reconstructed 3D scene and edited using the rendered viewpoint image, so that the movement of an object in the scene captured by the camera and the modification of the pose can be reflected in the 3D scene. This process is optimization for the original scene using the edited image. However, this method is based on sampling in a 3D scene, and is not suitable for the purpose of editing a 3D scene with a photograph taken in the real world as an input.

### SUMMARY

Therefore, techniques and systems for three-dimensional scene reconstruction and updating with fewer inputs are desired.

An aspect of this invention is a three-dimensional scene processing system, including: one or more processors; and one or more storage devices, wherein the one or more storage devices store a first three-dimensional representation model representing a three-dimensional scene, and the one or more processors are configured to execute: acquiring an update image corresponding to a part of the three-dimensional scene; estimating an update geometry representation and an update camera pose from the update image; generating a three-dimensional representation model for update by the update geometry representation and the update camera pose; and updating a local part of the first three-dimensional representation model by the three-dimensional representation model for update.

According to an aspect of this invention, a three-dimensional scene can be easily updated.

### BRIEF DESCRIPTION OF THE DRAWINGS

FIG. 1A is a block diagram illustrating a configuration example of a three-dimensional scene reconstruction and update system according to a first embodiment.

FIG. 1B is a diagram illustrating a configuration example of a computer.

FIG. 2 is a flowchart illustrating an example of processing of reconstructing a three-dimensional scene according to the first embodiment.

FIG. 3 is a flowchart illustrating processing of updating a configured three-dimensional scene according to the first embodiment.

FIG. 4 is a diagram illustrating an example of a user interface according to the first embodiment.

FIG. 5 is a flowchart illustrating a semantic three-dimensional scene reconstruction processing for identifying an update area according to a second embodiment and an update area identification processing based on a three-dimensional representation model acquired from the semantic three-dimensional scene reconstruction.

FIG. 6 is a flowchart illustrating processing of updating a constructed three-dimensional scene with a user text prompt according to a third embodiment as an input or complementing with a user input in a case where there is an area that an input image cannot cover.

FIG. 7 is a flowchart illustrating processing of automatically improving a low quality portion such as noise when the low quality portion exists in a reconstructed three-dimensional scene according to a fourth embodiment.

### DESCRIPTION OF THE EMBODIMENTS

In the following description, when it is necessary for convenience, the description will be divided into a plurality of sections or examples, but unless otherwise specified, the sections or examples are not unrelated to each other, and one is in a relationship of some or all modifications, details, supplementary explanation, and the like of the other. Furthermore, in the following, when referring to the number of elements and the like (including number, numerical value, amount, range, etc.), the number of elements is not limited to a specific number unless otherwise stated or unless clearly limited to the specific number in principle, and the number of elements may be greater than or equal to or less than the specific number.

A processor that is an arithmetic device realizes a predetermined function by executing a program stored in a memory that is a main storage device. The main storage device stores a program executed by the processor and data necessary for executing the program. The program includes a program in addition to an operating system (OS) (not illustrated). The processor may include a plurality of chips and a plurality of packages.

The program is executed by the processor to perform predetermined processing using the storage device and the communication port (communication device). Therefore, the description using the program as the subject in this embodiment and other embodiments may be a description using a processor as the subject. Alternatively, the processing executed by the program is processing performed by a computer and a computer system on which the program operates.

The processor operates as a functional unit (means) that realizes a predetermined function by operating according to the program. Furthermore, the processor also operates as a functional unit (means) that realizes each of a plurality of processes executed by each program. A computer and a computer system are devices and systems including these functional units (means).

### First Embodiment

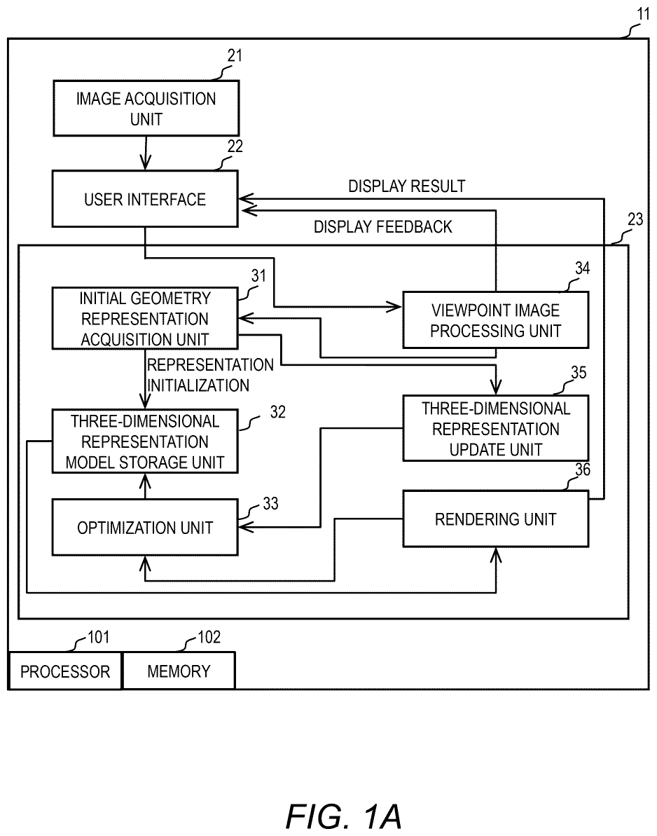

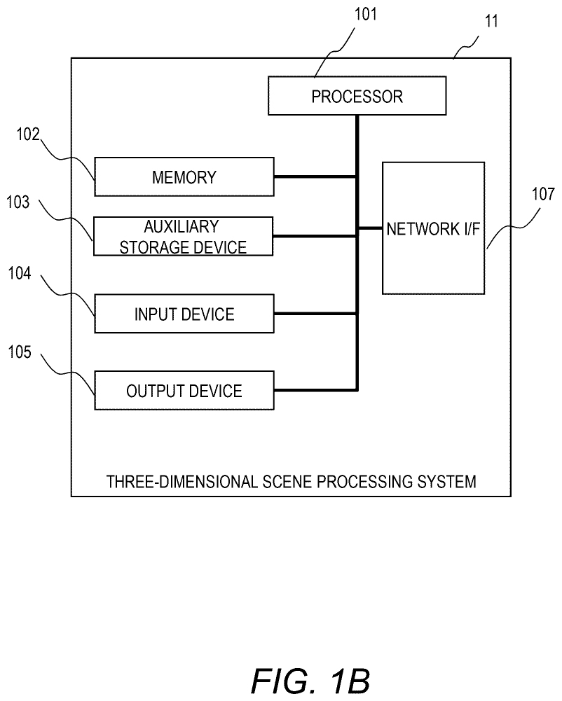

FIG. 1A is a block diagram illustrating a configuration example of a three-dimensional scene processing system 11 according to the first embodiment. As illustrated in FIG. 1A, the three-dimensional scene processing system 11 performs reconstruction of a three-dimensional scene and update processing based on the reconstruction. The three-dimensional scene processing system 11 includes an image acquisition unit 21 as an example of an “acquisition unit”, a user interface 22 as an example of an “interface”, and a three-dimensional scene reconstruction and update unit 23 as an example of a “three-dimensional scene processing unit”.

The three-dimensional scene processing system 11 further includes at least one processor 101 and at least one memory 102. The processor 101 reads and executes a predetermined computer program stored in the memory 102 to implement each function described later.

The image acquisition unit 21 reads, for example, an image captured by the user in the imaging facility. The image acquisition unit 21 can read a format for storing widely used RGB images, and can also be replaced with, for example, a device that captures RGB images. The image acquisition unit 21 outputs the acquired image to the user interface 22. At the same time, the image acquisition unit 21 performs preprocessing on the read image. For example, the image acquisition unit 21 unifies the resolution of the image to a necessary size. The image acquisition unit 21 outputs the processed image to the three-dimensional scene reconstruction and update unit 23.

The user interface 22 includes a communication interface and a user interface. The user interface 22 arranges the image input from the image acquisition unit 21 on the user interface, for example, in the input image display area. Further, the user interface 22 has a camera for the user to observe the three-dimensional scene. The camera receives an operation by the user. The user can observe the three-dimensional scene, which is the reconstruction result, in the display area while changing the viewpoint by operating the camera. Furthermore, depending on the implementation manner, for example, it is also possible to receive a text prompt for updating the three-dimensional scene and to display feedback from the three-dimensional scene reconstruction and update unit 23.

For example, the three-dimensional scene reconstruction and update unit 23 processes the image acquired by the image acquisition unit 21 and automatically reconstructs the three-dimensional scene by the input image. Furthermore, the three-dimensional scene reconstruction and update unit 23 outputs the three-dimensional scene of successful reconstruction to the user interface 22, and waits for input of an update image necessary for updating the three-dimensional scene. Furthermore, after completion of the reconstruction of the three-dimensional scene, in response to the user operating the camera via the user interface 22, the three-dimensional scene reconstruction and update unit 23 renders the image viewed from the same viewpoint based on the camera coordinates and the orientation (posture) in real time, and displays the image in the display area of the user interface 22.

As illustrated in FIG. 1A, the three-dimensional scene reconstruction and update unit 23 includes an initial geometry representation acquisition unit 31, a three-dimensional representation model storage unit 32, an optimization unit 33, a viewpoint image processing unit 34, a three-dimensional representation update unit 35, and a rendering unit 36.

The initial geometry representation acquisition unit 31 uses the input multi-view image to calculate or estimate a three-dimensional geometry representation. The multi-view image is a different image with different camera poses, and the camera poses are identified with the position (coordinates) and orientation of the camera. The geometry representation includes a point cloud, a mesh, and the like, and in this embodiment, a point cloud will be described as an example. The initial geometry representation acquisition unit 31 estimates the point cloud and also estimates the initial camera pose of the input image. In the initial geometry representation acquisition unit 31, a typical means is SfM.

In addition, for example, a learned stereo model such as a deep learning based method may be applied. The initial geometry representation acquisition unit 31 acquires the processed update image from the viewpoint image processing unit 34. Furthermore, other than the above means, it is also possible to randomly initialize the point cloud and provide the initial data regardless of the input of the image. By adopting such a means, it is not necessary to input an RGBD image or the like with high acquisition cost.

The three-dimensional representation model storage unit 32 initializes and stores the 3D Gaussian distribution along the three-dimensional representation model, for example, 3DGS, using the initial point cloud acquired from the initial geometry representation acquisition unit 31. The three-dimensional representation model may be formed by a method different from 3DGS, such as a mesh.

The optimization unit 33 uses the image of the user input and the initial camera pose calculated by the initial geometry representation acquisition unit 31 to adjust the parameters so that an image as close as possible to the input image can be rendered from each camera pose with respect to the three-dimensional representation model. For example, in a case where 3DGS is adopted as the three-dimensional representation model, by appropriately adjusting attributes such as center coordinates, a covariance matrix, colors (luminance, hue, saturation), and translucency for each 3D Gaussian distribution (splat), optimization is performed so that the rendering result approaches the input image as closely as possible. As a result, a three-dimensional representation model representing a high-quality three-dimensional scene can be constructed.

The viewpoint image processing unit 34 performs preprocessing such as integration of resolution on the input image. As an example, it is also evaluated whether a three-dimensional scene can be reconstructed with respect to the input image. The viewpoint image processing unit 34 performs feedback to the user via the user interface 22 on an image that cannot be constructed as a three-dimensional scene, for example, because there is no overlap between multi-view input images or image quality is low, for example, there is a defect in the input image. This feedback may be executed for an input image for updating the three-dimensional model in addition to the processing of newly generating the three-dimensional model. When there is no problem, the processed image data is passed to the initial geometry representation acquisition unit 31. In the case of only basic image preprocessing such as resolution processing, merging into the initial geometry representation acquisition unit 31 is also possible.

After the reconstruction of the three-dimensional scene, the three-dimensional representation update unit 35 edits the three-dimensional representation model by moving the changed reality information with respect to a partial area, an object, or the like with respect to the three-dimensional representation model, for example, moving a mug on a desk and erasing the mug from the area, and in a case where it is desired to update the information that the mug disappears also in the same area in the three-dimensional scene, the update point cloud is acquired through the initial geometry representation acquisition unit 31 using the update image acquired again from the image acquisition unit 21, and the point cloud is geometrically updated with respect to the three-dimensional representation model. When a random point cloud is adopted as the three-dimensional representation model, the processing of the three-dimensional representation update unit can be skipped.

The rendering unit 36 is responsible for generating an image from a designated viewpoint based on the initial three-dimensional representation model or the optimized three-dimensional representation model and the camera parameters (for example, camera pose, focal length, output size, etc.). At this time, the rendering processing includes, for example, a splatting technology based on a 3D Gaussian distribution and use of spherical harmonics for performing viewpoint-dependent color interpolation.

In addition, by simultaneously generating auxiliary visual information such as a depth image and a normal map, further analysis and visualization are enabled. As a result, the rendering unit 36 realizes high-quality and efficient image generation. It is also possible to render the three-dimensional scene stored in the three-dimensional representation model storage unit 32 in real time according to the camera designated by the user interface 22, pass the result to the user interface 22, and display the result.

FIG. 1B illustrates a hardware configuration example of the three-dimensional scene processing system 11. FIG. 1B illustrates an example having a general computer configuration, and includes a processor 101 which is an arithmetic device, a memory 102 which is a main storage device, an auxiliary storage device 103, an input device 104, an output device 105, and a network interface 107. The parts of the three-dimensional scene processing system 11 are communicably connected to each other via a communication means such as a bus. Note that all or a part of the configuration of the three-dimensional scene processing system 11 may be realized by a virtual resource such as a cloud server.

The processor 101 is configured using a central processing unit (CPU), a micro processing unit (MPU), a graphics processing unit (GPU), or the like. The processor 101 reads and executes the program stored in the memory 102, thereby implementing the functions of the three-dimensional scene processing system 11.

The memory 102 is a device that stores programs and data, and is a read only memory (ROM), a random access memory (RAM), a non-volatile RAM (NVRAM), or the like.

The auxiliary storage device 103 is, for example, a solid state drive (SSD), an NVRAM such as an SD memory card, an optical storage device such as a compact disc (CD) or a digital versatile disc (DVD), a hard disc drive (HDD), a storage area of a cloud server, or the like. The auxiliary storage device 103 includes a non-transitory storage medium that stores programs and data. The programs and data stored in the auxiliary storage device 103 are read into the memory 102 as needed.

The input device 104 is an interface that receives input of information, and is, for example, a keyboard, a mouse, a touch panel, a card reader, a microphone, or the like. Alternatively, the three-dimensional scene processing system 11 may be configured to receive an input of information with another device via a communication means. The output device 105 is an interface that outputs various types of information, and is, for example, a screen display device such as a liquid crystal monitor, a liquid crystal display (LCD), a graphic card, a printing device, or an audio output device such as a speaker. Alternatively, the three-dimensional scene processing system 11 may be configured to output information to another device via a communication means.

The network interface 107 is a device for the three-dimensional scene processing system 11 to communicate with other devices. Some of the components illustrated in FIG. 1B may be omitted, and other components may be added.

The three-dimensional scene processing system 11 can include one or more computers. As such, the three-dimensional scene processing system 11 may include one or more processors and one or more storage devices. One or more processors operate as a predetermined functional unit including the functional unit illustrated in FIG. 1A by executing a program stored in one or more storage devices.

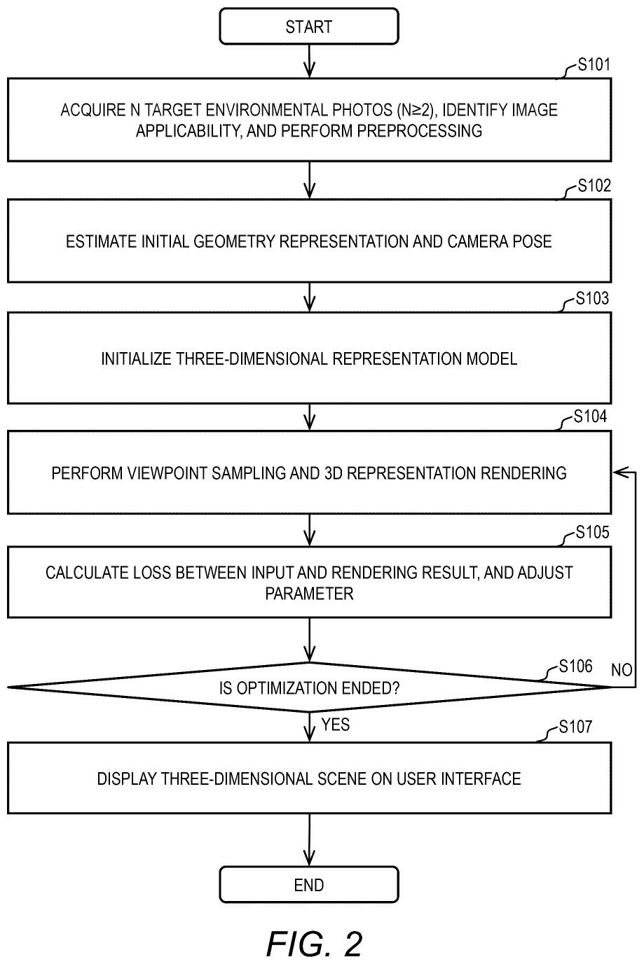

FIG. 2 is a flowchart illustrating an example of three-dimensional scene reconstruction processing according to the first embodiment.

The image acquisition unit 21 receives an input of an image (multi-view image) of an environment as a target of three-dimensional reconstruction (S101). For example, the client program (the image acquisition unit 21 and the user interface 22) is operated, and the image acquisition unit 21 reads image data input by the user via the user interface 22.

Next, the viewpoint image processing unit 34 performs preprocessing (for example, standardization of resolution between images and the number of channels, etc.) on the acquired image as necessary, detects overlap between the images, and transmits feedback to the user interface 22 in a case where the image cannot be used for three-dimensional reconstruction, such as a case where the degree of overlap is less than a preset threshold, and requests the user to reinput the image. When there is no problem in the image data, the preprocessed image is passed to the initial geometry representation acquisition unit 31.

Next, the initial geometry representation acquisition unit 31 estimates the initial geometry representation and the camera pose based on Structure from Motion, for example. Specifically, the initial geometry representation acquisition unit 31 uses the input multi-viewpoint image to estimate an initial point cloud to be used for the three-dimensional representation model, for example, using a learned stereo model or the like, and simultaneously acquires an initial camera pose for each image with respect to the input of the multi-viewpoint image (S102). In addition, estimation based on COLMAP is also possible.

Next, the three-dimensional representation model storage unit 32 acquires an initial point cloud from the initial geometry representation acquisition unit 31, and initializes the three-dimensional representation model (S103). For example, in a case where 3DGS is adopted as the three-dimensional representation model, a Gaussian distribution (Gaussian Splat) is assigned to each point based on the initial point cloud obtained by the initial geometry representation acquisition unit 31. Specifically, the position (center coordinates) of each point, the covariance matrix (parameter representing the distribution shape of the point cloud), and the basic color attribute (luminance, hue, etc.) are initialized.

At this time, the covariance matrix is calculated based on the local density and distribution direction of the point cloud. Furthermore, in order to adapt the initialized 3DGS to the viewpoint of the camera, the projected shape (two-dimensional covariance matrix) of each point is transformed into the camera coordinate system. As a result, each Gaussian splat is accurately arranged on the screen, and efficient rendering can be performed. In addition, if necessary, the co-visibility (consistency of a region that looks common between viewpoints) is checked for the initialized point cloud, and inconsistency points are removed to reduce redundancy. This improves the quality of the initial 3DGS model and improves the convergence of subsequent optimization processing. Through such a process, the 3DGS is initialized, and the basis for smooth transition to the subsequent optimization processing is prepared.

Next, the optimization unit 33 optimizes the three-dimensional representation model based on the input multi-viewpoint image and initial camera pose. The optimization is a process of enabling rendering of an image approximate to an input image by adjusting a three-dimensional representation model and camera parameters based on an input multi-viewpoint image.

In this process, camera poses are sampled, a three-dimensional representation model is rendered (S104), and parameters of the three-dimensional representation model (For example, a center coordinate, a covariance matrix, a color attribute, and the like of the 3D Gaussian distribution.) and camera parameters are iteratively adjusted (S105) with the aim of minimizing photometric errors between the rendering image and the input image.

Furthermore, by adding geometry information output at the time of rendering, for example, a depth image, a normal map, or the like, and geometry information estimated by the learned stereo model to a photometric error, simultaneous optimization of three-dimensional representation with higher accuracy and camera parameters is achieved. Examples of the photometric error include a mean squared error (MSE) for calculating an inter-image distance. Rendering is performed by the rendering unit 36. The processing procedure of the optimization unit 33 can also cope with optimization using only a minority input image. There are many such optimization methods, and as an example, InstantSplat that can reconstruct 3DGS with as few as two images can be cited.

When the photometric error falls below the certain level or reaches the designated number of optimization times (S106: YES), the optimization ends, and the process proceeds to the next step S107. Otherwise (S106: NO), the process returns to step S104.

In the case of the optimization end, for the three-dimensional representation model, a default camera pose of the user interface 22 is acquired, rendering is performed, and the result is displayed on the user interface 22.

The processing procedure of the three-dimensional scene processing system 11 gradually ends.

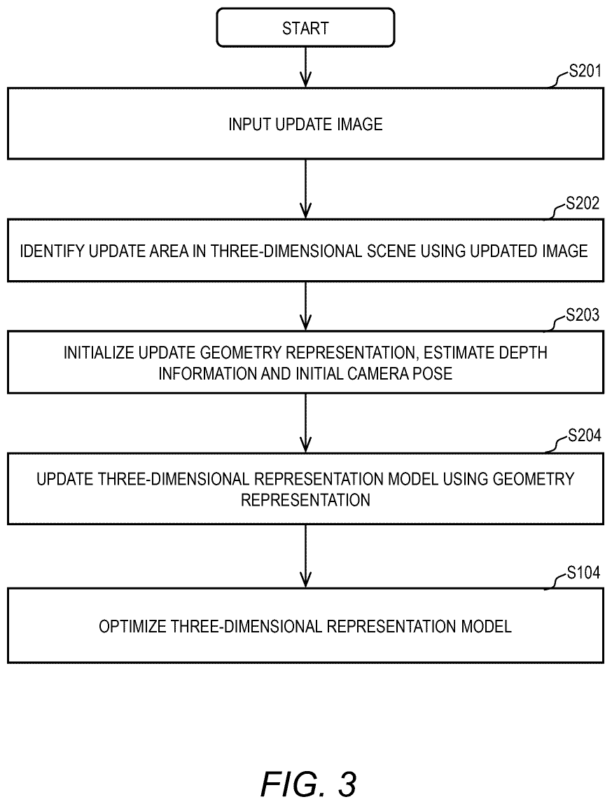

FIG. 3 is a flowchart illustrating processing of updating the three-dimensional representation model with the update image according to the first embodiment.

The viewpoint image processing unit 34 acquires an input image for updating the three-dimensional representation model via the user interface 22 (S201). The update image is, for example, an image reflecting a change in a partial environment (for example, a change in a fixed object such as a wall or a floor) or a case where an object located in a specific area is moved or removed in a real scene expressed by a three-dimensional representation model. For example, it is assumed that the cup on the desk is removed in a three-dimensional scene of the entire office. As the update image, an image on a desk from which the cup has been removed is given.

When the three-dimensional representation model is updated, the updated area in the three-dimensional scene is identified using the update image (S202). The updated area is a partial area corresponding to the update image in the three-dimensional scene. The updated area can be identified by comparing an image generated by rendering from the three-dimensional representation model or an input image with an update image. The update area may be identified by, for example, the method of the second embodiment. Next, the viewpoint image processing unit 34 inputs the update image and the update area information to the initial geometry representation acquisition unit 31. The update area information may include an image of the update area and information on the camera.

Next, using the acquired update image, the initial geometry representation acquisition unit 31 acquires the update initial point cloud and the initial camera pose of the update image according to S102 (S203). The acquired camera information including the update point cloud and the camera pose is passed to the three-dimensional representation update unit 35. Furthermore, in a case where there is only one update image input by the user, it is also possible to generate an image from a different viewpoint by using a new viewpoint image generative AI model, for example, Zero123 or the like, and acquire an update initial point cloud and a camera pose.

The three-dimensional representation update unit 35 refers to the update area information acquired in S202 as necessary, compares the update point cloud with the point cloud information included in the three-dimensional representation model, and performs alignment in which the orientation and position of the update point cloud are matched with the orientation and position of the point cloud included in the three-dimensional representation model. As a result, a more appropriate three-dimensional representation model for update can be generated. The update point cloud is also pruned as necessary. The purpose of the pruning is to remove an area other than the area that matches the point cloud of the three-dimensional representation model the most when the range of the point cloud acquired by the initial geometry representation acquisition unit 31 is too large.

For example, after the alignment, a bounding box is calculated for an area overlapping the main, and deletion is performed for an area other than the bounding box area. There is a method such as an iterative closest point (ICP) for adjusting the orientation and position of the point cloud. The three-dimensional representation model initialization is performed on the point cloud after the pruning according to S103, and the three-dimensional representation model for update is acquired. The three-dimensional representation model for update is a local (partial) three-dimensional representation model of the three-dimensional scene.

Next, the three-dimensional representation model for update is merged with the original three-dimensional representation model to acquire a new three-dimensional representation model (S204). As a result, it is not necessary to perform optimization on the entire three-dimensional representation model at the time of update, and it is possible to perform optimization only on the local (partial).

The optimization of the three-dimensional representation model is performed using the camera pose of the input update image and the estimated update image with respect to the newly acquired three-dimensional representation model. The optimization processing refers to the processing from S104. In the optimization at the time of update, camera sampling is performed around the target area, and the update can be efficiently performed.

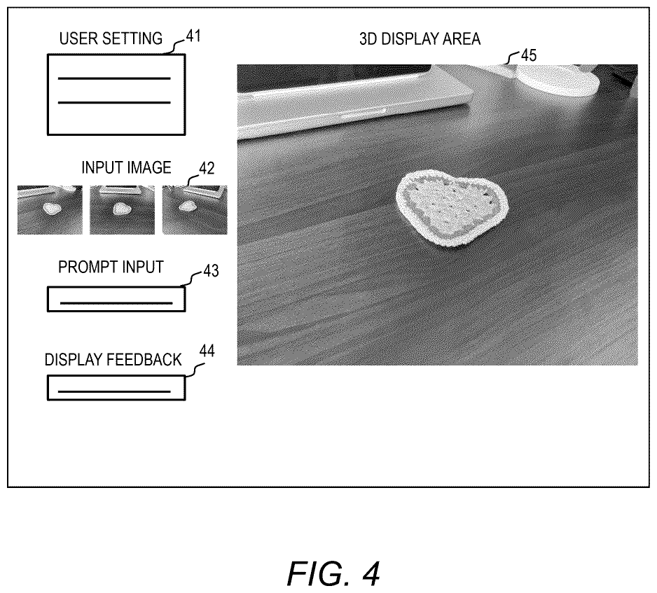

FIG. 4 illustrates an example of the user interface 22. The user interface 22 displays a user setting 41, an input image 42, a prompt input 43, a feedback display 44, and a 3D display area 45.

The user setting 41 receives settings used in the optimization process, for example, parameters such as a constraint condition and an end condition, and a setting term. The setting condition can include information such as the number of times of optimization and a threshold of overlapping of images.

The input image 42 becomes available as necessary. The input image 42 previews an image acquired by the user from the image acquisition unit 21. The user checks the acquired image, and acquires a new image from the image acquisition unit 21 when the user wants to change the acquired image. In FIG. 4, one input image is indicated by reference numeral 42.

The prompt input 43 is available as needed. When performing update by a text prompt or the like (described later), the user inputs an instruction through the prompt input 43.

The feedback display 44 is available as needed. For example, in a case where there is no overlap between the input images, there is a defect in the image, or the like, or in a case where it is not suitable or difficult to reconstruct the three-dimensional scene, the viewpoint image processing unit 34 can display the fact in the form of text or an analysis image on the feedback display 44 to request further action of the user. The input image may be an initial image and an update image for creating a three-dimensional representation model.

The 3D display area 45 is an area for displaying a three-dimensional scene of the completion of reconstruction. For example, on the user interface 22 side, a renderer for rendering a three-dimensional representation model is executed, and the user operates a virtual camera of a 3D display area with a mouse or the like, and displays an image of an area captured by the virtual camera while rendering.

Furthermore, in the 3D display area 45, it is also possible to implement only a camera operation, transmit a camera pose to the three-dimensional scene reconstruction and update unit 23 every time there is a camera operation, and cause the three-dimensional scene reconstruction and update unit 23 to render an image of a viewpoint designated in real time, return the image, and display the image in the 3D display area 45.

The user can perform reconstruction and updating of the three-dimensional scene by using the user interface 22 illustrated in FIG. 4.

According to this configuration, the three-dimensional scene processing system 11 includes the image acquisition unit 21, the user interface 22, and the three-dimensional scene reconstruction and update unit 23. The image acquisition unit 21 acquires, for example, an RGB image. The user interface 22 is in charge of a function of interaction between the user and the three-dimensional scene, such as reception of an instruction from the user and a role of acting as a bridge of image input. The three-dimensional scene reconstruction and update unit 23 constructs the three-dimensional representation model using the input image, optimizes the parameters and the like of the designated area of the target three-dimensional representation model based on the update data and the instruction of the user, and updates the three-dimensional representation model.

As a result, the user can easily reconstruct the three-dimensional scene by a small number of inputs without performing complicated processing, and further perform high-speed local update on the designated area, so that the user can easily update the three-dimensional scene and quickly construct and manage the three-dimensional scene. For example, the three-dimensional scene of the entire room can be reconstructed by inputting only several photographs that can cover the entire room. In addition, the system automatically updates the target area only by removing the mug on the desk, taking several photographs for updating the area where the mug is present, and inputting the photographs.

In the user interface 22, simple image acquisition operation and instruction input operation by the user are required, and the operability and editing of the user can be facilitated.

The three-dimensional scene reconstruction and update unit 23 includes the viewpoint image processing unit 34 that can perform preprocessing and availability determination of an input image by using several input images or an update image, the initial geometry representation acquisition unit 31 that acquires a point cloud, the three-dimensional representation model storage unit 32 that initializes the point cloud to a three-dimensional representation model, the optimization unit that optimizes the three-dimensional representation model with the input image and the estimated camera pose, the three-dimensional representation update unit 35 that updates the geometry representation of the three-dimensional representation model using the update image and identifies an update area, and the rendering unit 36 that quickly renders the three-dimensional representation model to an image. As a result, the three-dimensional scene can be easily reconstructed or updated at a high speed.

### Second Embodiment

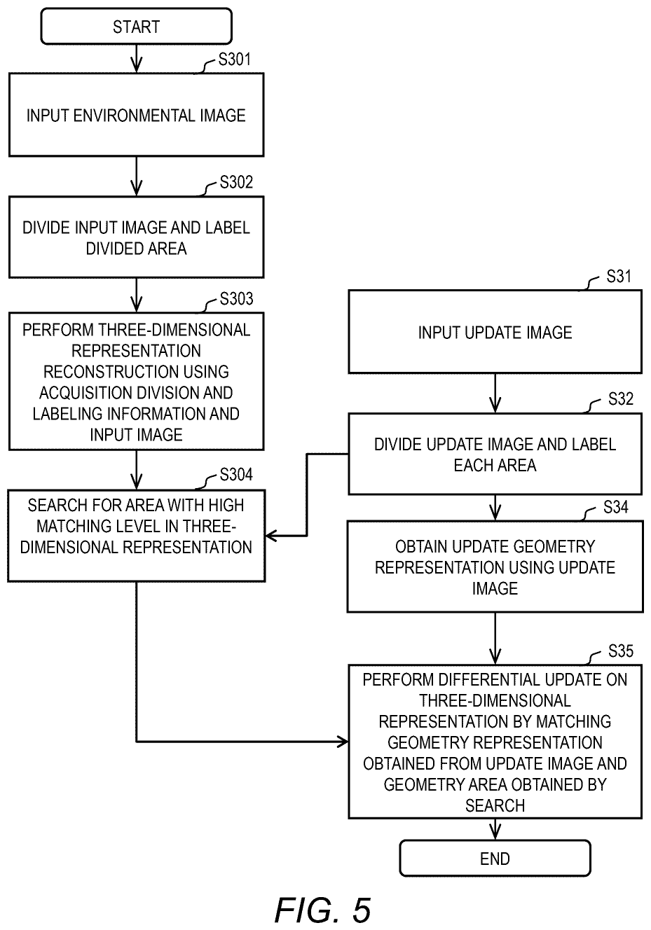

The three-dimensional scene processing system according to a second embodiment will be described with reference to FIG. 5. In the second embodiment, in the viewpoint image processing unit 34, the semantic level is generated at the time of the preprocessing on the input image in step S101 of the first embodiment, and the division is simultaneously executed, so that the semantic three-dimensional scene is reconstructed, thereby reducing the specific computation cost and time of the update area at the time of update. The main changes will be described with reference to FIG. 5.

FIG. 5 is a flowchart illustrating an example of enabling update area automatic search and identification at the time of three-dimensional scene update according to the second embodiment.

As illustrated in FIG. 5, the viewpoint image processing unit 34 performs semantic division and labeling on the input environment image (S301) (S302). For example, Semantic-SAM can be used as a semantic division method based on the latest research trend.

Next, the divided three-dimensional representation model is reconstructed using the acquired information such as a mask and a label (S303). When reconstructing the divided three-dimensional representation model for the initial geometry representation acquisition unit 31, the three-dimensional representation model storage unit 32, the optimization unit 33, and the like, a method such as Segment Any 3D GAussians can be adopted based on the latest research trend. This makes it possible to quickly search for an object or an area in a three-dimensional scene and to identify a specific object.

Next, when updating the information with respect to the three-dimensional scene, the viewpoint image processing unit 34 performs semantic segmentation similarly with respect to the update image, and performs division and labeling (S32).

Next, the three-dimensional representation update unit 35 searches for an area that most matches the object and the area detected in the update image or satisfies a predetermined standard of matching in the semantic three-dimensional scene (S304). The matching may be performed based on update area information such as the type of label, the number of labels of each type, and the position of the divided area of the label. In addition, similarity between images may be referred to, and a part of the information of the label may be omitted.

At the same time, the update geometry representation is acquired from the initial geometry representation acquisition unit 31 using the update image (S34). As in the first embodiment, a case where a point cloud is adopted for geometry representation will be described.

Next, the three-dimensional representation update unit 35 combines the geometry representation acquired from the update image, that is, the point cloud with the geometry area acquired in step S304, matches the position and orientation using ICP or the like, acquires a difference, and merges the difference with the original geometry representation. An update three-dimensional model is generated from the merged geometry representation, and the update three-dimensional model is merged with the original three-dimensional model. As a result, the three-dimensional representation model can be updated only for the updated area (S35).

According to this embodiment, for example, it is not necessary to take a means for rendering a large amount of images for a three-dimensional representation model, creating a feature amount index, and searching for an update image, and it is possible to identify an update area at a high speed.

### Third Embodiment

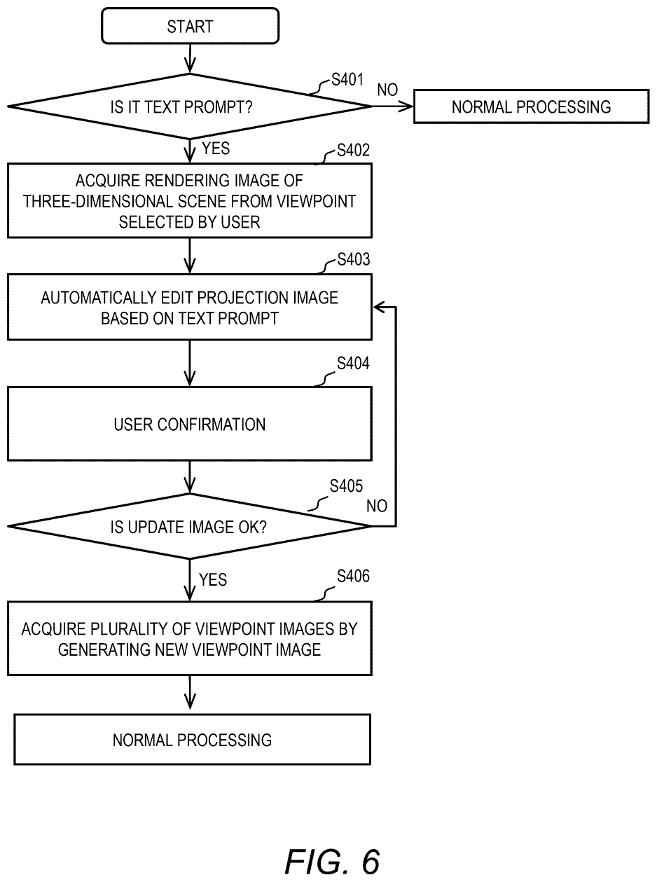

The three-dimensional scene processing system according to a third embodiment will be described with reference to FIG. 6. In the third embodiment, the update image acquisition process by the image acquisition unit 21 is eliminated with respect to the update image input steps S201 and S31 in the first and second embodiments, and the user can update the three-dimensional representation model by an instruction of only text via the user interface 22. Furthermore, in the same processing, the user can interactively correct the image acquired via the image acquisition unit 21 in a case where there is a blank area such as an unphotographable area due to physical restriction or the like. The main changes will be described with reference to FIG. 6.

FIG. 6 is a flowchart illustrating processing of updating a constructed three-dimensional scene with a user text prompt according to the third embodiment as an input or complementing with a user input in a case where there is an area that an input image cannot cover.

As illustrated in FIG. 6, instead of acquiring the updated image through the image acquisition unit 21, the user inputs a text-based instruction into the prompt input 43 of the user interface 22. For example, the user operates the virtual camera in the 3D display area 45 to search for an area to be updated. After causing the target area to be displayed in the 3D display area 45 through the virtual camera, the user enters an update instruction in the prompt input 43. For example, “remove the mug on the desk” is input. Next, in step S401, the input type is determined. When the result of S401 is true (S401: YES), the process proceeds to step S402. Otherwise (S401: NO), the process proceeds to normal processing, for example, S201 or S31.

Then, when the result of S401 is true (S401: YES), the camera pose selected by the user together with the text prompt input and the image rendered by the camera pose, that is, the image finally displayed in the 3D display area 45, are acquired (S402), and the editing update is performed on the acquired image by using the prompt. Specifically, the target image is updated by adopting an image generative AI model, for example, Stable Diffusion (S403). Next, the updated image is displayed on the feedback display 44, and the confirmation of the user is requested (S405). When the result of S405 is true (S405: YES), the process proceeds to S406. Otherwise (S405: NO), the process returns to S403 to update the image again.

Next, for the updated image, a new viewpoint image generative AI model such as Zero123 is used to generate another viewpoint image (S406). As a result, the preparation of the update image is completed, and the process proceeds to normal processing, for example, S201 or S31.

With such a change, in the first and second embodiments, the three-dimensional representation model can be updated by the user inputting only the text prompt. Furthermore, when the three-dimensional representation model is reconstructed, in a case where there is an area that cannot be covered in the input image and the area cannot be three-dimensionally reconstructed, the user can repair the three-dimensional representation model by inputting, for example, “place a desk in an empty portion and supplement background” to the area via the user interface 22.

### Fourth Embodiment

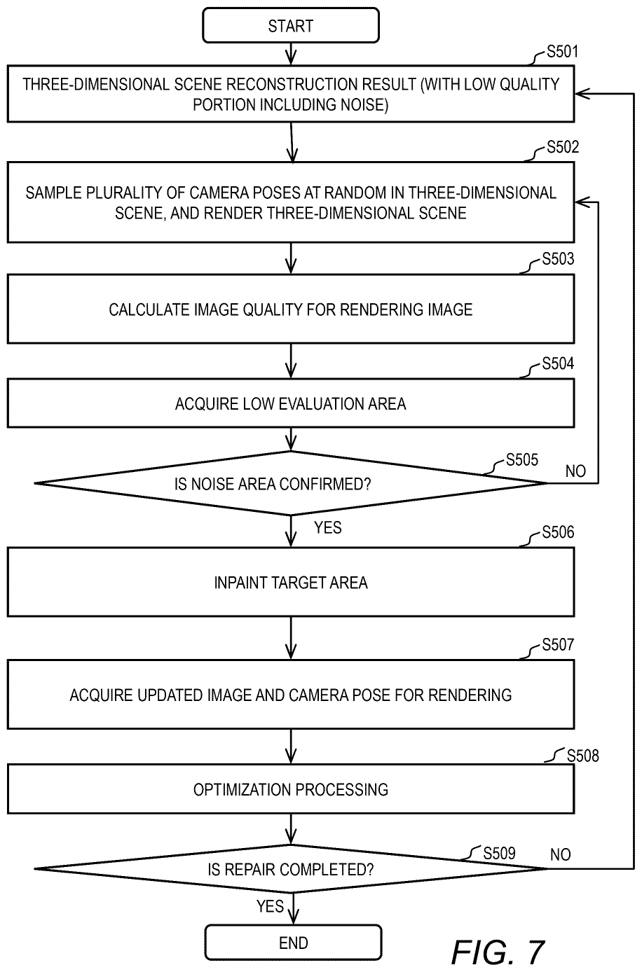

A three-dimensional scene processing system according to a fourth embodiment will be described with reference to FIG. 7. In the fourth embodiment, the reconstructed three-dimensional representation model in the first and second embodiments enables automatic detection and improvement of noise or poor quality in a rendered image.

FIG. 7 is a flowchart illustrating processing of automatically improving a low quality portion such as noise when the low quality portion exists in a reconstructed three-dimensional scene according to the fourth embodiment.

As illustrated in FIG. 7, this embodiment is performed when there is noise or the like in a three-dimensional scene (S501). In this processing, the system renders the three-dimensional scene a plurality of times by randomly sampling the three-dimensional scene with a plurality of virtual cameras. At the time of camera sampling, if the position and orientation of the camera are set so that a wider area can be covered with as few cameras as possible, the computation cost can be reduced. For example, sampling is performed by four cameras, and arrangement is performed so as to cover 360 degrees (S502).

Next, in step 503, the viewpoint image processing unit 34 evaluates image quality of each rendering image. For the evaluation of the image, a method of generally evaluating the image such as Structural Similarity Index Measure (SSIM), Peak Signal-To-Noise Ratio (PSNR), or CLIP-Score (Contrastive Language-Image Pretraining Score) may be adopted.

Next, in the rendering image, an area having the lowest score or an area less than the threshold is selected as the current target area (S504). Basically, this evaluation can be performed a plurality of times. For example, after the number of times of evaluation of the low score area is set in advance by the user interface 22 or the like, in a case where the set number of times is reached, the evaluation is ended, and the process proceeds to S506 (S505: YES). Otherwise (S505: NO), the evaluation is performed again from S502. When the evaluation is performed again, the previously selected target area is centered. When the evaluation is performed again, any other rule can be adopted. For example, an area in which the lowest score or the score lower than the threshold in the previous evaluation is obtained is set as the target area.

Next, in step S506, the image of the finally set target area is inpainted from noise or the like using an image generative AI model, for example, Stable Diffusion. When adopting a model that requires text input, such as Stable Diffusion, for example, a prompt may be set according to a situation, such as “removing noise in an image”, or a more versatile prompt may be set.

In step S507, the updated image and the camera pose of the same image are acquired. Here, it is also possible to acquire a plurality of images and camera poses in accordance with the number of times of performing image inpainting. In that case, it is possible to optimize the three-dimensional representation model using all of these images and camera information. After the image and the camera information are acquired, normal update processing (optimization processing) S508 is executed. For example, the process proceeds to S104 or the like. Next, the restoration result is fed back to the user interface 22 to request confirmation from the user. For example, in a case where it is determined from the user confirmation that the restoration has been completed (S509: YES), the process ends. When further restoration is necessary (S509: NO), the process proceeds to S501, and the process is performed again. Furthermore, in a case where the user determines that it is necessary, the process proceeds to the third embodiment, for example, S401, and restoration can be continued under the user guide.

In this way, it is possible to improve the three-dimensional scene representation quality of the three-dimensional representation model by designing a mechanism for automatically evaluating and improving the rendering image quality.

This invention is not limited to the plurality of embodiments described above, and includes other modifications having different input and different constraint conditions used for optimization. Note that the three-dimensional scene processing system 11 including the user interface described in this specification is a set of a plurality of functions, and is not limited to the configuration as illustrated in the drawings. For example, the image acquisition unit 21 may be implemented as a part of the function of the user interface 22. The processing steps in each processing process do not need to be performed in order unless there is a contradiction.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD, or a storage medium such as an IC card, or an SD card.

The drawings show control lines and information lines as considered necessary for explanations but do not show all control lines or information lines in the products. It can be considered that almost of all components are actually interconnected.

What is claimed is:

1. A three-dimensional scene processing system, comprising:
one or more processors; and
one or more storage devices, wherein
the one or more storage devices store a first three-dimensional representation model representing a three-dimensional scene, and
the one or more processors are configured to execute:
acquiring an update image corresponding to a part of the three-dimensional scene;
estimating an update geometry representation and an update camera pose from the update image;
generating a three-dimensional representation model for update by the update geometry representation and the update camera pose; and
updating a local part of the first three-dimensional representation model by the three-dimensional representation model for update.

2. The three-dimensional scene processing system according to claim 1, wherein
the one or more processors are configured to execute:
acquiring a plurality of input images;
estimating an initial geometry representation and an initial camera pose from the plurality of input image;
performing initialization of the first three-dimensional representation model with the initial geometry representation and the initial camera pose;
performing parameter adjustment of the first three-dimensional representation model based on a rendering image by the initialized first three-dimensional representation model and an input image;
storing, in the one or more storage devices, the first three-dimensional representation model on which the parameter adjustment has been executed; and
updating, by the three-dimensional representation model for update, a local part of the first three-dimensional representation model on which the parameter adjustment has been executed.

3. The three-dimensional scene processing system according to claim 1, wherein
the one or more processors render and display an image of a viewpoint selected by a user in the three-dimensional scene by the first three-dimensional representation model.

4. The three-dimensional scene processing system according to claim 2, wherein
the one or more processors generate an evaluation result as to whether the plurality of input images or the update image is suitable for representation of the three-dimensional scene, and feed back the evaluation result to the user.

5. The three-dimensional scene processing system according to claim 2, wherein
the one or more processors are configured to execute:
adding geometry information including a depth image and a normal map of the input image and geometry information including a depth image and a normal map in rendering by the first three-dimensional representation model to a photometric error; and
performing parameter adjustment of the first three-dimensional representation model by the photometric error.

6. The three-dimensional scene processing system according to claim 1, wherein
the one or more processors perform alignment by comparing the update geometry representation with a geometry representation of the first three-dimensional representation model, and
generating a three-dimensional representation model for update by the aligned update geometry representation and the update camera pose.

7. The three-dimensional scene processing system according to claim 1, wherein
the first three-dimensional representation model is a semantic three-dimensional representation model, and
the one or more processors are configured to execute:
performing semantic division on the update image;
identifying an update area based on a semantic degree of match with the update image in a three-dimensional scene represented by the first three-dimensional representation model; and
updating the first three-dimensional representation model in an update area.

8. The three-dimensional scene processing system according to claim 1, wherein
the one or more processors are configured to execute:
acquiring an image rendered with the first three-dimensional representation model by a camera pose selected by a user; and
updating the acquired image according to an instruction from the user to generate the update image.

9. The three-dimensional scene processing system according to claim 1, wherein
the one or more processors are configured to execute:
performing camera sampling in a three-dimensional scene by the first three-dimensional representation model;
selecting an inpainting area based on quality evaluation of a rendering result by the camera sampling in the three-dimensional scene;
performing inpainting on a rendering image of the inpainting area;
updating a parameter of the first three-dimensional representation model using the rendering image on which the painting has been performed.

10. A three-dimensional scene processing method executed by a system, wherein
the system stores a first three-dimensional representation model representing a three-dimensional scene,
the three-dimensional scene processing method causes the system to execute:
acquiring an update image corresponding to a part of the three-dimensional scene;
estimating an update geometry representation and an update camera pose from the update image;
generating a three-dimensional representation model for update by the update geometry representation and the update camera pose; and
updating a local part of the first three-dimensional representation model by the three-dimensional representation model for update.
